(19) United States
(12) Patent Application Publication
(10) Pub. No.: US 2006/0259760 A1
(43) Pub. Date: Nov. 16, 2006

(54) Method and apparatus to support communication services using delayed authentication

(75) Inventors: Mankesh Ahluwalia, Hoffman Estates, IL (US); Chandra Warrier, Schaumburg, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 11/126,085

(22) Filed: May 10, 2005

(51) Int. Cl. H04L 9/00

(52) U.S. Cl. 713/153

(57) ABSTRACT

Upon receiving (101) a user node request for communication services, which request requires system authentication, a network entity can initiate (104) provision of the requested services while intentionally delaying (105) any attempt to seek such authentication. Following that intentional delay, the network element can then transmit (106) an authentication request (for example, to an authentication entity such as an Authentication, Authorization, and Accounting server) for that user node. When that authentication request is denied, the network entity can respond by terminating (108) the previously initiated communication service.

### TECHNICAL FIELD

This invention relates generally to communication services and more particularly to communication protocols that ordinarily require authentication of a given user to support facilitation of such services for that user.

### BACKGROUND

Many communication systems require authentication of a given user before requested communication services are provided to that user. Such authentication serves a number of valid and important purposes including but not limited to ensuring that a given user who is requesting services is in fact authorized to receive such services. Viewed another way, permitting system access without also requiring authentication can render it difficult for a system operator to be fairly compensated for system usage.

In many systems, an authentication entity (such as an Authentication, Authorization, and Accounting (AAA) server) provides such authentication. There are times, however, when such an approach can be problematic. For example, such an authentication entity can be temporarily unavailable to process authentication requests (due, for example, to downtime or undue loading that overwhelms the immediate capacity of that authentication entity to process such requests in a timely manner). When such delays occur, the user in question is denied service pending completion of the authentication process. This, in turn, can result in an unsatisfactory user experience for authorized and legitimate system users.

Authentication processing capability can be increased, of course, to attempt to ameliorate such concerns. This approach, however, tends to be capital intensive and can also burden the communication system with additional task allocation and synchronization complexity. Administrative overhead may also increase.

### BRIEF DESCRIPTION OF THE DRAWINGS

The above needs are at least partially met through provision of the method and apparatus to support communication services using delayed authentication described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a call flow diagram as configured in accordance with various embodiments of the invention; and

FIG. 4 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, upon receiving a communication service request from a user node, which communication service request requires authentication by an authentication entity, the receiving network entity may determine to delay transmission of a corresponding authentication request to the authentication entity and to initiate provision of the requested service prior to receiving the necessary authentication. Later (following, for example, conclusion of a predetermined period of time), this network entity can transmit the necessary authentication request to the authentication entity. Upon receiving an authentication grant from the authentication entity, the network entity can continue providing the already-supported service. When, however, the network entity receives an authentication denial from the authentication entity, the network entity can terminate provision of the previously initiated communication service.

Depending upon the needs of a particular application, the above-mentioned determination to delay transmission of an authentication request can be based upon, for example, presently perceived loading of the authentication entity.

So configured, services to authorized users will not be unnecessarily delayed due to current unavailability of the otherwise necessary authentication. At the same time, however, unauthorized users, while being able to gain initial temporary access to the communication system, will not ordinarily be able to maintain that attachment for very long as the authentication process will still be carried forth following initiation of the service in question. Upon determining the unauthorized status of such a user, the system can terminate those services and therefore likely minimize the impact of unauthorized usage on the system and its users.

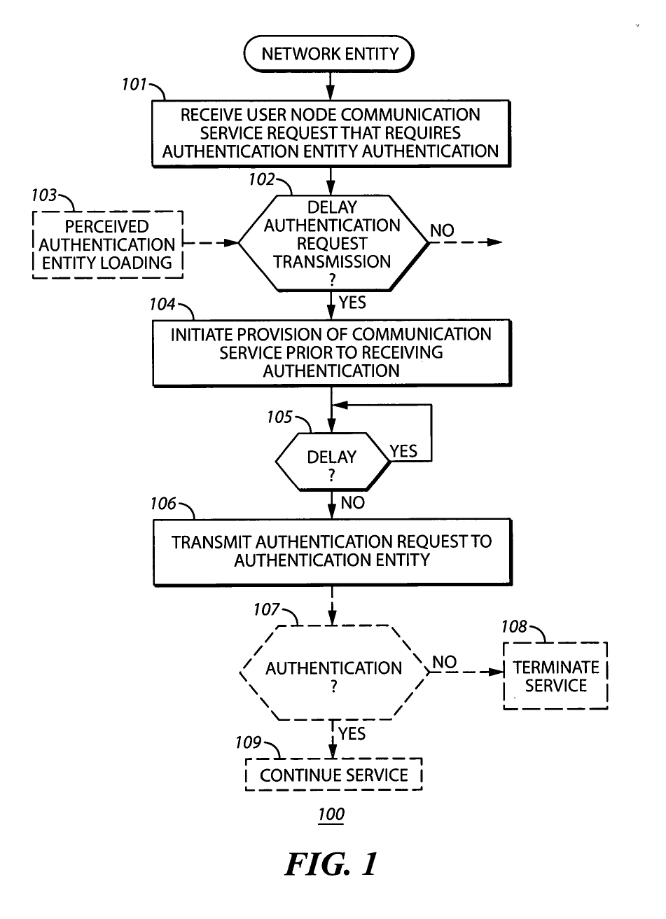

These and other benefits may become clearer upon making a thorough review and study of the following detailed description. Referring now to the drawings, and in particular to FIG. 1, a process 100 to be preferably employed by an appropriate network entity (such as, but not limited to, a Packet Data Serving Node (PDSN)) will be described.

Upon receiving 101 a communication service request (such as, but not limited to, at least one of a Password Authentication Protocol (PAP) request and a Challenge/Handshake Authentication Protocol (CHAP) response) from a user node (such as, but not limited to, a wireless mobile station as are known in the art), which communication service request requires authentication by an authentication entity (such as, but not limited to, an Authentication, Authorization, and Accounting server as are known in the art), the network entity determines 102 to delay transmission of a corresponding authentication request for that user node to that authentication entity.

If desired, this determination can comprise an automatic default selection in favor of such a delay. In a preferred embodiment, however, this determination comprises a dynamic process. For example, in an optional but preferred approach, this determination 102 can be made as a function, at least in part, of perceived loading of the authentication entity 103. To illustrate, the network entity may monitor latency between when an authentication request is transmitted and when a corresponding authentication grant or denial from the authentication entity is received. As another illustrative example, the authentication entity may provide signaling that specifically reflects its own present (and/or historical or anticipated) loading. Other possibilities are available as well and no doubt yet other approaches will be developed in the future. It would also be possible, of course, to base the indicated perception upon two or more indicia of this sort in combination.

When this determination 102 comprises a dynamic process, and when the network entity determines 102 that no delay need be imposed, the network entity can respond to the authentication need in its usual and customary manner. Upon determining, however, to effect such a delay, the network entity can initiate 104 provision of the requested (or otherwise sought) communication service (for example, by engaging in Internet Protocol Control Protocol (IPCP) negotiations with the user node) prior to receiving the otherwise necessary authentication. In other words, the network entity can provide the requested service, which otherwise requires authentication, notwithstanding a present absence of such authentication and notwithstanding that the network entity has itself purposefully delayed seeking such authentication.

This process 100 then provides for a delay 105 having, in a preferred approach, a predetermined duration. The duration of this delay period can be varied dynamically, if desired, based upon criteria of choice. For example, the duration can be lengthened or shortened based upon a perception of present loading of the authentication entity. (Those skilled in the art will recognize that the steps shown, and their order of execution, are so presented with an intent to explain and describe the actions being taken. In particular, it will be understood and appreciated that such steps need not occur in the specific order shown or even, necessarily, as separate and discrete steps. To illustrate, the network entity could first initiate a delay countdown and then take specific action to initiation provision of the requested service. Accordingly, the steps described in FIG. 1 shall be understood to be illustrative in this regard rather than specific.)

At the conclusion of the delay period, the network entity then transmits 106 a corresponding authentication request to the authentication entity. This can comprise, for example, an ordinary authentication request as is already well understood in the art. Upon receiving an authentication response from the authentication entity, the network entity then determines 107 whether that response comprises an authentication grant or an authentication denial. When the response comprises an authentication denial, the network entity will preferably respond by terminating 108 the previously initiated communication service for the user node. Conversely, when the response comprises an authentication grant, the network entity will preferably respond by continuing 109 to support provision of the previously initiated communication service for the user node.

So configured, it should be readily apparent that these teachings permit a service request to receive quick attention and resultant service access notwithstanding present availability of remote authentication services, notwithstanding a system requirement that such a service request be authenticated. By deploying these teachings in a dynamic context, it can further be seen that the decision to effect a delay (and/or the duration of that delay) can vary with the need. For example, as loading increases the duration of the delay can increase and vice versa.

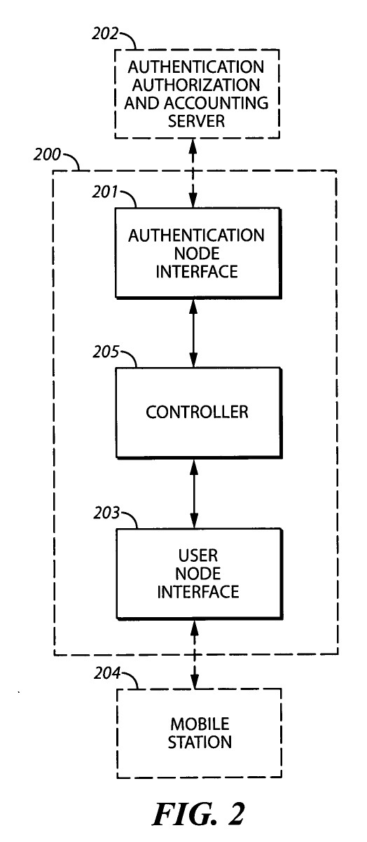

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

A network entity 200 (such as a Packet Data Serving Node) can comprise an authentication node interface 201 (such as an Authentication, Authorization, and Accounting server interface to facilitate communications with a corresponding Authentication, Authorization, and Accounting server 202) and a user node interface 203 (such as a wireless mobile station interface to facilitate communications with a corresponding mobile station 204). Such interfaces are well known and understood in the art and require no further elaboration here.

In a preferred approach the network entity 200 further comprises a controller 205. This controller 205 will preferably comprise a partially or wholly programmable platform though a fixed-purpose platform can be employed where desired. In a preferred approach this controller 205 is programmed to facilitate the previously described steps. In particular, this controller 205 is configured and arranged to facilitate mobile station communication service requests (as are received via the user node interface 203) by providing communication services to that mobile station prior to transmitting an authentication request for that mobile station to an authentication entity via the authentication node interface 201.

This controller 205 is also preferably programmed to automatically delay transmitting such an authentication request (where this delay is optionally, but preferably, effected as a function, at least in part, of perceived loading of the authentication entity). And lastly, this controller 205 is also preferably configured and arranged to automatically terminate such a communication service upon receiving an authentication rejection from the authentication entity via the authentication node interface 201.

So configured, such a network entity 200 is able, upon receiving a service request from a given user node, to provide corresponding communication services even while delaying transmission of a corresponding authentication request to a system authentication entity. Furthermore, such a network entity 200 is also able, upon eventually receiving a negative response to such a delayed authentication request, to then automatically terminate the earlier initiated service or services.

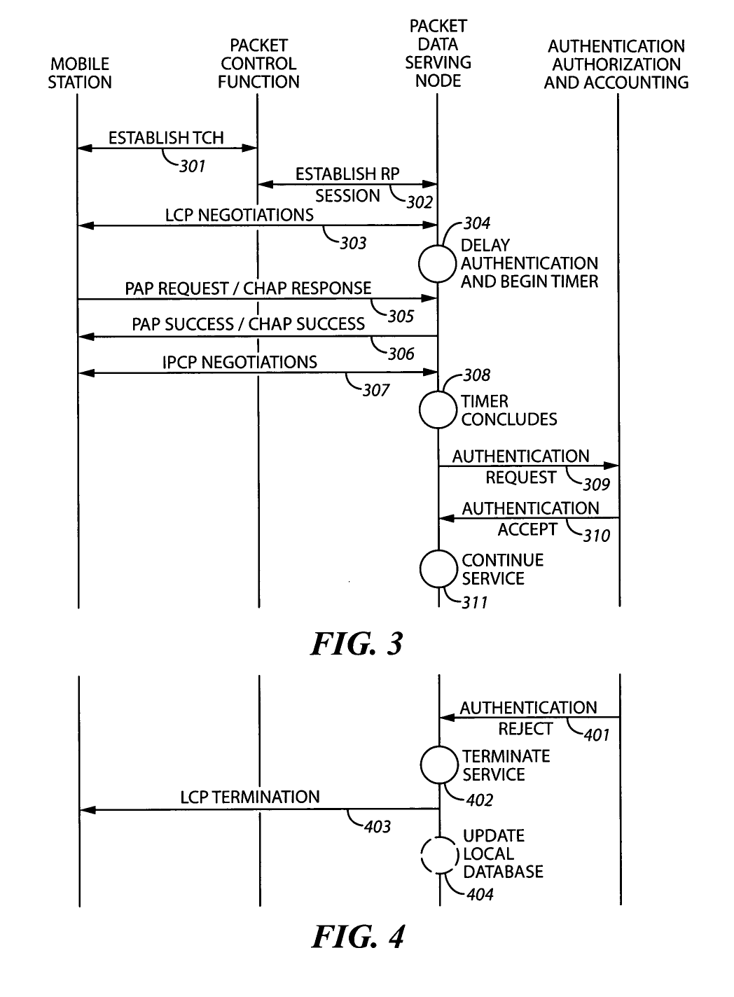

Referring now to FIG. 3, an illustrative and non-limiting example will be provided.

In this example, a mobile station establishes a traffic channel (TCH) 301 with a Packet Control Function (PCF) in accordance with prior art practice in this regard. The Packet Control Function, in turn, establishes a RAN (Radio Access Network)-PDSN (Packet Data Serving Node) (RP) session 302 with a Packet Data Serving Node that comprises the platform to effect the teachings set forth herein. In this illustrative example the Packet Data Serving Node then effects Link Control Protocol (LCP) negotiations 303 with the mobile station while determining to delay authentication and to begin a corresponding delay timer 304. In accordance with prior art practice, the mobile station then transmits a PAP request/CHAP response 305 and the Packet Data Serving Node responds, in this case, with a PAP success/CHAP success message 306 notwithstanding a present absence of required authentication. The latter two network elements then conduct IPCP negotiations 307 in furtherance of providing the requested services.

Meantime, eventually, the delay timer concludes 308. When this happens the Packet Data Serving Node then transmits an authentication request 309 to an Authentication, Authorization, and Accounting server. In this example, the mobile station is, in fact, a legitimate system participant and the AAA server responds with an authentication accept message 310. The Packet Data Serving Node responds by continuing the communication services 311 already begun for this mobile station.

It will be noted that the Packet Data Serving Node communicates no further authentication information to the mobile station following receipt of authentication confirmation. Although such information could be transmitted if desired, in general such a message is unnecessary as the mobile station already perceives that it has been authenticated given the early exchanges between itself and the Packet Data Serving Node.

In a case where the mobile station does not comprise an authorized system participant for whatever reason, and referring now to FIG. 4, the AAA server will return an authentication reject message 401 to the Packet Data Serving Node in response to the earlier proffered authentication request (not shown). In response, the Packet Data Serving Node will now respond by automatically terminating the earlier initiated services 402 which can include, in this particular example, transmitting an LCP termination message 403.

If desired, the Packet Data Serving Node can update a local database 404 to reflect this un-authenticated status of this mobile station. So configured, the Packet Data Serving Node can access this database to determine whether a mobile station has already been denied authentication. When true, the Packet Data Serving Node could then deny newly requested services until, for example, authentication is confirmed by the relevant authentication entity.

Those skilled in the art will appreciate that these teachings resolve and/or avoid many of the issues that presently trouble existing systems. In particular, the user experience (for legitimate users) tends to be improved due to reduced delay even during heavy traffic conditions. At the same time, exposure of the system operator to undue unauthorized usage remains limited and ultimately, still, largely under system control.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A network entity comprising:
a user node interface;
an authentication node interface;
a controller configured and arranged to facilitate a communication service for a user node upon receiving a request for such communication service from the user node via the user node interface wherein facilitating the communication service commences prior to transmitting an authentication request for the user node to an authentication entity via the authentication node interface.

2. The network entity of claim 1 wherein the network entity comprises a Packet Data Serving Node (PDSN).

3. The network entity of claim 1 wherein the user node interface comprises a wireless mobile station interface.

4. The network entity of claim 1 wherein the authentication node interface comprises an Authentication, Authorization, and Accounting (AAA) server interface.

5. The network entity of claim 1 wherein the controller is further configured and arranged to automatically delay transmitting the authentication request.

6. The network entity of claim 5 wherein the controller is further configured and arranged to automatically delay transmitting the authentication request as a function, at least in part, of perceived loading of the authentication entity.

7. The network entity of claim 1 wherein the controller is further configured and arranged to automatically terminate the communication service upon receiving an authentication rejection from the authentication entity via the authentication entity interface.

8. The network entity of claim 1 wherein the controller further comprises means for:
receiving a service request from the user node which service request requires authentication from the authentication entity;
in response to receiving the service request, facilitating provision of a communication service for the user node while delaying transmission of a corresponding authentication request to the authentication entity.

9. A method for use by a network entity comprising:
receiving a communication service request from a user node, which communication service request requires authentication by an authentication entity;
determining to delay transmission of an authentication request for the user node to the authentication entity;
initiating provision of the communication service prior to receiving authentication from the authentication entity;
transmitting the authentication request to the authentication entity following a period of delay.

10. The method of claim 9 wherein the network entity comprises a Packet Data Serving Node.

11. The method of claim 9 wherein determining to delay transmission of an authentication request for the user node to the authentication entity comprises determining to delay the transmission as a function, at least in part, of perceived loading of the authentication entity.

12. The method of claim 9 further comprising:
continuing provision of the communication service upon receiving an authentication grant from the authentication entity in response to transmitting the authentication request.

13. The method of claim 9 further comprising:
terminating provision of the communication service upon receiving an authentication denial from the authentication entity in response to transmitting the authentication request.

14. The method of claim 9 wherein:
receiving a communication service request from a user node comprises receiving at least one of a Password Authentication Protocol (PAP) request and a Challenge/Handshake Authentication Protocol (CHAP) response; and
initiating provision of the communication service comprises engaging in Internet Protocol Control Protocol (IPCP) negotiations with the user node.

15. A method comprising:
receiving, at a first network entity, a communication service request from a user node;
determining, at the first network entity, to delay transmitting an authentication request to an authentication entity and providing the communication service to the user node during the delay;
transmitting, at the first network entity, the authentication request after the delay;
receiving, at the authentication entity, the authentication request;
determining, at the authentication entity, whether the user node should be authenticated;
transmitting, at the authentication entity, an authentication grant when the user node should be authenticated and an authentication denial when the user node should not be authenticated;
terminating, at the first network entity, the communication service upon receiving the authentication denial and continuing the communication service upon receiving the authentication grant.

16. The method of claim 15 wherein the first network entity comprises a Packet Data Serving Node.

17. The method of claim 16 wherein determining to delay transmitting an authentication request to an authentication entity comprises determining to delay transmitting the authentication request to an authentication entity as a function, at least in part, of perceived loading of the authentication entity.
